(19) United States
(12) Patent Application Publication
(10) Pub. No.: US 2026/0267025 A1
(43) Pub. Date: Sep. 10, 2026

(54) C-A-R-E METAL DETECTOR SYSTEMS

(71) Applicant: Tanisha Adams, Concord, NC (US)

(72) Inventor: Tanisha Adams, Concord, NC (US)

(21) Appl. No.: 19/449,996

(22) Filed: Jan. 15, 2026

Related U.S. Application Data
(60) Provisional application No. 63/745,441, filed on Jan. 15, 2025.

(51) Int. Cl. G01V 3/10; G08B 3/10; G08B 13/181; G08B 25/00

(52) U.S. Cl. CPC G01V 3/10; G08B 3/10; G08B 13/181; G08B 25/009

(57) ABSTRACT

The C-A-R-E Metal Detector forms an upside-down U, starting at the bottom of the door frame, climbing to the top, cutting across the top, and descending to the other side, which creates an electromagnetic field. The system is used in buildings with doors. If an individual passes through the device with a gun, the gun is recognized and an initial signal is transmitted to the second sensor, which alerts the security system.

### CROSS-REFERENCE TO RELATED APPLICATION

The present application is related to and claims priority from prior provisional application Ser. No. 63/745,441, filed Jan. 15, 2025 which application is incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of metal detection and more specifically relates to metal detector security systems.

### 2. Description of the Related Art

Security is desired in many locations and applications modernly. Conventional metal detectors are large and expensive. Further, the present solutions do not communicate outside of their immediate range to warn of impending danger.

Various attempts have been made to solve the above-mentioned problems such as those found in U.S. Pat. No. 9,886,833 to Bryan Lee Noland. This art is representative of metal detection. None of the above inventions and patents, taken either singly or in combination, is seen to describe the invention as claimed.

Ideally, a metal detection means should provide security and, yet would operate reliably and be manufactured at a modest expense. Thus, a need exists for a reliable metal detector system to avoid the above-mentioned problems.

### BRIEF SUMMARY OF THE INVENTION

In view of the foregoing disadvantages inherent in the known metal detection art, the present invention provides a novel metal detector system. The general purpose of the present invention, which will be described subsequently in greater detail is to provide a cost-effective and smart metal detection means.

C-A-R-E Metal Detector forms an upside-down U, starting at the bottom of the door frame, climbing to the top, cutting across the top, and descending to the other side creating an electromagnetic field. The system is used in buildings with doors. If an individual passes through the device with a gun, the gun is recognized and an initial signal is transmitted to the second sensor, which alerts the security system. The second sensor's job is to send a warning to a mobile app or an already-installed security system.

Based on what the user has specified, the sensor determines the location of the intruder. The police are notified, as well as other entities recognized in the system. Police can respond more swiftly and will know the intruder's initial location, allowing them to find and end the threat more rapidly. Those with security alerts in the building can also take swift action to get people to safety because they will know where the access point is.

A metal detector system comprising: at least one transmitter coil configured to create an electromagnetic field; at least one sensor comprising a receiver coil to detect electromagnetism; a control; at least one audio speaker to emit alarm sounds upon receiving an appropriate signal; at least one battery; a Wi-Fi connector to facilitate internet connection and allows Wi-Fi capability; a top cover which covers a top part of a care metal detector; a base; and a Wi-Fi extender housing to house a circuit, the at least one battery and the Wi-Fi connector; and a Wi-Fi circuit board; the Wi-Fi connectors connectable to a Wi-Fi antenna, the Wi-Fi antenna extending a useful envelope of the Wi-Fi capability of the care metal detector; a Wi-Fi extender top to cover the Wi-Fi extender housing; a Wi-Fi extender antenna link to connect the Wi-Fi capability to the Wi-Fi antenna; and a sticky pad for removably mounting the metal detector system to a door frame.

The at least one battery in a preferred embodiment comprises 0.9 inch ultra-thin rechargeable polymer battery for powering the metal detector system. The detection comprises a presence of ferrous materials; wherein the detection of the presence of the ferrous materials is indicated via sending the appropriate signal. The at least one audio speaker upon receipt of the appropriate signal causes the alarm to emit an audible signal. The (first or second) sensor is able to determine a location via coordinates of an intruder having a presence of the ferrous material; wherein the sensor is able to relay the location of the intruder to a remote electronic device; wherein the remote electronic device comprises a smart phone or may be a non-smart phone in alternate embodiments. The smart phone (if used) comprises and operates a mobile software application. The sensor is able to relay the location of the intruder to an already-installed security system. The already-installed security system is preferably in communication with a police force. When mounted the metal detector system forms an inverted U, starting at a bottom of the door frame, climbing to a top of the door frame, cutting across the top of the door frame, and descending from the top of the door frame to the bottom of the door frame, and configured to create an electromagnetic field in the door frame for use in detection.

A kit is disclosed including: the metal detector system, and a set of user instructions.

A method of using a metal detector system comprising the steps of: providing the metal detector system; installing the metal detector system to existing door frames; and installing a mobile software application. The method may further comprise the steps of: connecting a smart phone with the mobile software application to an internet via Wi-Fi.

The present invention holds significant improvements and serves as a metal detector system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, CARE metal detector system (metal detector system), constructed and operative according to the teachings of the present invention.

FIG. 1 shows a top view illustrating a metal detector system according to an embodiment of the present invention.

FIG. 2 is a perspective view illustrating the metal detector system according to an embodiment of the present invention of FIG. 1.

FIG. 3 is a perspective view illustrating a sticky pad in a rolled-up condition prior to installation according to an embodiment of the present invention.

FIG. 4 is a front view illustrating a Wi-Fi extender of the metal detector system according to an embodiment of the present invention.

FIG. 5 is a side view illustrating the Wi-Fi extender of the metal detector system according to an embodiment of the present invention.

FIG. 6 is a top perspective view illustrating the Wi-Fi extender of the metal detector system according to an embodiment of the present invention.

FIG. 7 is a top view of the Wi-Fi extender of the metal detector system with a top cover separated from a lower structure according to an embodiment of the present invention.

FIG. 8 is a bottom view of the Wi-Fi extender of the metal detector system with a top cover separated from a lower structure according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to a metal detector and more particularly to a metal detector system as used to improve the efficiency of installation and communication of such a device.

Generally speaking the present invention, the metal detector system comprises: at least one transmitter coil configured to create an electromagnetic field; at least one sensor comprising a receiver coil to detect electromagnetism; a control; at least one audio speaker to emit alarm sounds upon receiving an appropriate signal; at least one battery; a Wi-Fi connector to facilitate internet connection and allows Wi-Fi capability; a top cover which covers a top part of a care metal detector; a base; and a Wi-Fi extender housing to house a circuit, the at least one battery and the Wi-Fi connector; and a Wi-Fi circuit board; the Wi-Fi connectors connectable to a Wi-Fi antenna, the Wi-Fi antenna extending a useful envelope of the Wi-Fi capability of the care metal detector; a Wi-Fi extender top to covers the Wi-Fi extender housing; a Wi-Fi extender antenna link to connect the Wi-Fi capability to the Wi-Fi antenna; and a sticky pad for removably mounting the metal detector system to a door frame; and wherein when mounted the metal detector system forms an inverted U, starting at a bottom of the door frame, climbing to a top of the door frame, cutting across the top of the door frame, and descending from the top of the door frame to the bottom of the door frame, and configured to create an electromagnetic field in the door frame for use in detection. The door frame typically comprises a metal frame in a rectangular shape with a left and right side wall and a top and bottom (however the bottom may be absent and just be a floor surface that the door frame is mounted on or to).

The at least one battery of the metal detector system, in preferred embodiments, comprises 0.9 inch ultra-thin rechargeable polymer battery for powering the metal detector system. The detection comprises a presence of ferrous materials, such as a firearm or the like. The detection of the presence of the ferrous materials is indicated via sending the appropriate signal. The at least one audio speaker upon receipt of the appropriate signal causes the alarm to emit an audible signal or signals. The sensor is able to determine a location via coordinates of an intruder having a presence of the ferrous material. The sensor is able to relay the location of the intruder to a remote electronic device. The remote electronic device comprises a smart phone or may be a non-smart phone. The smart phone comprises and operates a mobile software application in smart phone versions.

The sensor is able to relay the location of the intruder to an already-installed security system. The already-installed security system is preferably in communication with a police force. The police force is able to be notified of the location of the intruder. The detection may comprise a presence of non-ferrous materials in alternate embodiments. The sticky pad is in a rolled-up condition prior to installation for ease of shipping.

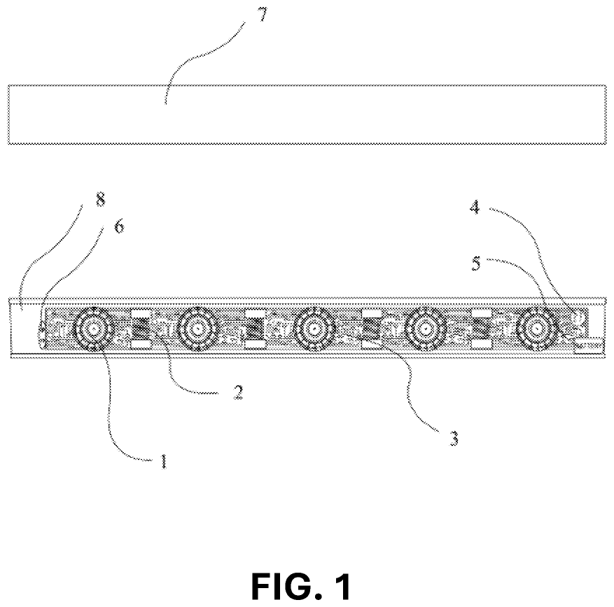

Referring to the drawings by numerals of reference there is shown in FIGS. 1-8, a C-A-R-E Metal Detector (metal detector system) which forms an upside-down U, starting at the bottom of the door frame, climbing to the top, cutting across the top, and descending to the other side, which creates an electromagnetic field. The various components of the system are as follows: Transmitter coils 1 creates an electromagnetic field; Sensor 2 comprises a receiver coil that detects electromagnetism; Control 3 is the electronic components of the present invention; Audio speaker 4 emits alarm sounds upon appropriate signal; Battery 5, in preferred embodiments, comprises 0.9 inch ultra-thin rechargeable polymer battery that powers the present invention; Wi-Fi device 6 allows Wi-Fi capability; Top cover 7 covers the top part of the CARE Metal Detector; Base 8 houses the unit; Wi-Fi Extender housing 9 houses the circuit, battery and Wi-Fi connector; Wi-Fi Circuit Board 10 comprises necessary Wi-Fi components; Wi-Fi Connectors 11 connects to the Wi-Fi antenna 12; Wi-Fi Antenna 12 extends the Wi-Fi useful envelope of the CARE Metal Detector; Wi-Fi Extender top 13 covers the housing; Wi-Fi Extender antenna link 14 connects the Wi-Fi circuitry to the antenna 12; and Sticky pad 15 allows the unit to be attached to virtually any surface.

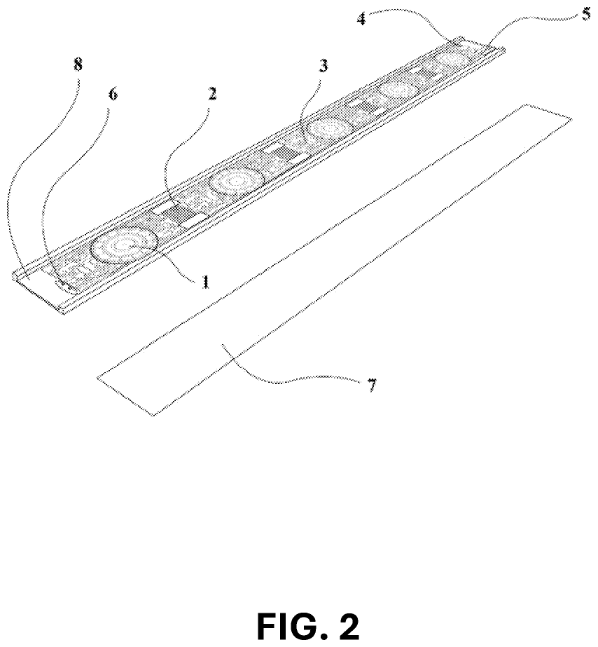

FIG. 1 shows a top view illustrating a metal detector system according to an embodiment of the present invention. Top cover 7 is shown which covers the top part of the CARE Metal Detector. Base 8 houses the unit and provides mounting for transmitter coils 1, sensor 2, control 3, audio speaker 4, and battery 5. FIG. 2 is a perspective view illustrating the metal detector system according to an embodiment of the present invention of FIG. 1. Wi-Fi device 6 allows Wi-Fi capability.

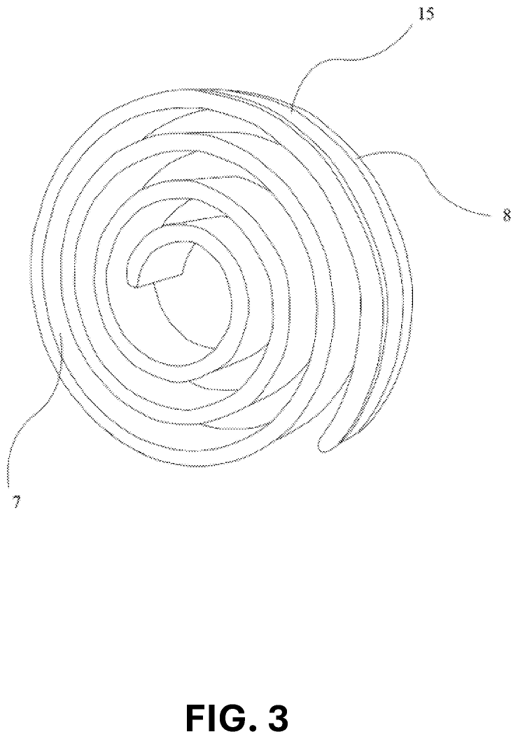

FIG. 3 is a perspective view illustrating the sticky pad 15 in a rolled-up condition prior to installation according to an embodiment of the present invention. Sticky pad 15 allows the unit to be attached to virtually any surface. Base 8 houses the unit. Top cover 7 is also shown.

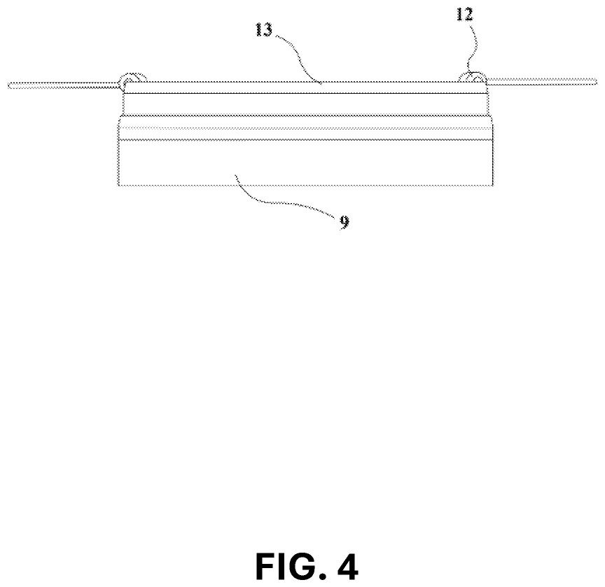

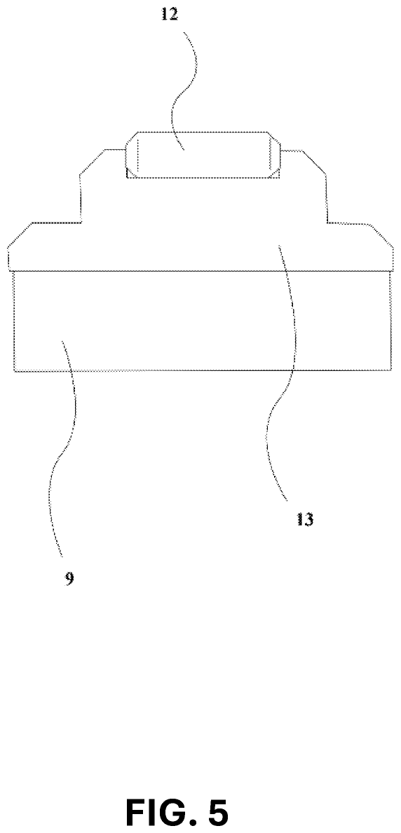

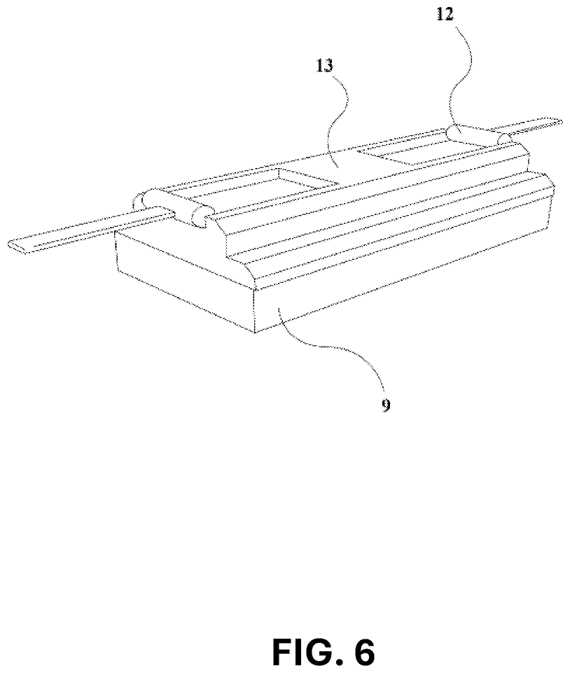

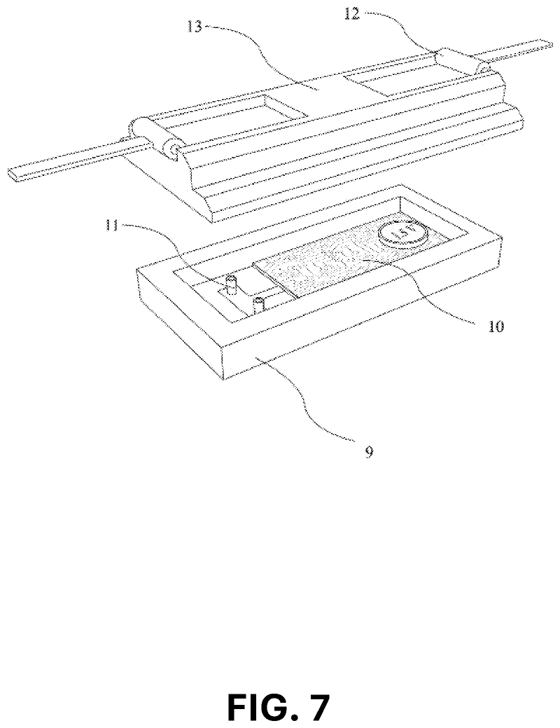

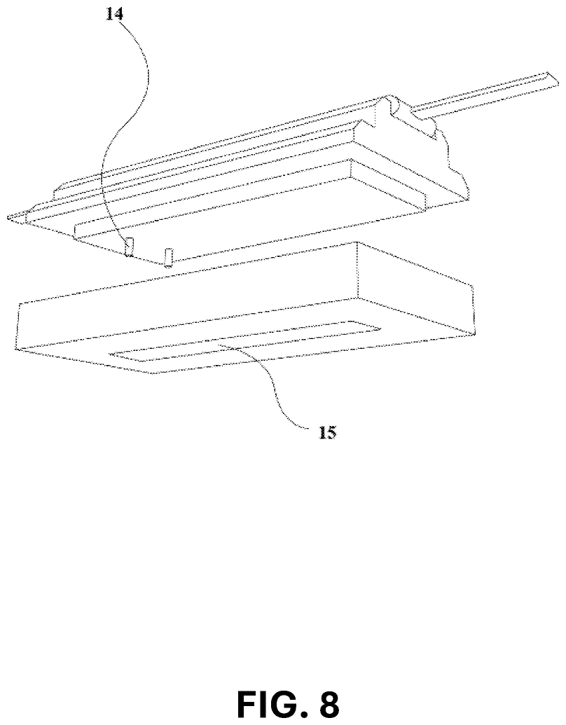

FIG. 4 is a front view illustrating a Wi-Fi extender of the metal detector system according to an embodiment of the present invention of FIG. 1. Wi-Fi Connectors 11 connects to the Wi-Fi antenna 12. Wi-Fi Antenna 12 extends the Wi-Fi useful envelope of the CARE Metal Detector; Wi-Fi Extender top 13 covers the housing. Wi-Fi Extender housing 9 houses the circuit board 10, battery 5 and Wi-Fi connectors 11. FIG. 5 is a side view illustrating the Wi-Fi extender of the metal detector system according to an embodiment of the present invention. Wi-Fi Antenna 12 extends the Wi-Fi useful envelope of the CARE Metal Detector; Wi-Fi Extender top 13 covers the housing. FIG. 6 is a top perspective view illustrating the Wi-Fi extender of the metal detector system according to an embodiment of the present invention. FIG. 7 is a top view of the Wi-Fi extender of the metal detector system with a top cover separated from a lower structure according to an embodiment of the present invention. FIG. 8 is a bottom view of the Wi-Fi extender of the metal detector system with a top cover separated from a lower structure according to an embodiment of the present invention.

The system is used in buildings with doors. If an individual passes through the device with a gun; the ferrous characteristics of the gun are recognized and an initial signal is transmitted to the second sensor, which alerts the security system. The second sensor's job is to send a warning to a mobile app or an already-installed security system. Based on what the user has specified, the sensor determines the location of the intruder. The police are notified, as well as other entities recognized in the system. Police can respond more swiftly and will know the intruder's initial location, allowing them to find and end the threat more rapidly. Those with security alerts in the building can also take swift action to get people to safety because they will know where the access point is.

The C-A-R-E Metal Detector is designed with the capacity to adhere or attach a metal detector to a door frame. The core of the technology is concealed in a thin, measurable, and paintable strip (or suitable equivalent) that may fit on a door frame and makes it difficult to see.

The system may be sold as kit comprising the necessary components as detailed above; and at least one set of user instructions. The kit has instructions such that functional relationships are detailed in relation to the structure of the invention (such that the invention can be used, maintained, or the like in a preferred manner). The kit may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different color combinations, parts may be sold separately, etc., may be sufficient.

The present invention can be provided; installed for use; turned to an on-condition so it can communicate as determined by the user/installer. A method of using a metal detector system comprising the steps of: providing the metal detector system; installing the metal detector system to existing door frames; and installing a mobile software application. The method may further comprise the steps of: connecting a smart phone with the mobile software application to an internet via Wi-Fi.

It should be noted that the steps described in the method of use can be carried out in many different orders according to user preference. The use of “step of” should not be interpreted as “step for”, in the claims herein and is not intended to invoke the provisions of 35 U.S.C. § 112, ¶ 6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A metal detector system comprising:
at least one transmitter coil configured to create an electromagnetic field;
at least one sensor comprising a receiver coil to detect electromagnetism;
a control;
at least one audio speaker to emit alarm sounds upon receiving an appropriate signal;
at least one battery;
a Wi-Fi connector to facilitate internet connection and allows Wi-Fi capability;
a top cover which covers a top part of a care metal detector;
a base; and
a Wi-Fi extender housing to house a circuit, the at least one battery and the Wi-Fi connector; and a Wi-Fi circuit board; said Wi-Fi connectors connectable to a Wi-Fi antenna, said Wi-Fi antenna extending a useful envelope of the Wi-Fi capability of the care metal detector; a Wi-Fi extender top to covers the Wi-Fi extender housing; a Wi-Fi extender antenna link to connect the Wi-Fi capability to the Wi-Fi antenna; and
a sticky pad for removably mounting said metal detector system to a door frame; and
wherein when mounted said metal detector system forms an inverted U, starting at a bottom of the door frame, climbing to a top of the door frame, cutting across the top of the door frame, and descending from the top of the door frame to the bottom of the door frame, and configured to create an electromagnetic field in said door frame for use in detection.

2. The metal detector system of claim 1 wherein said at least one battery comprises 0.9 inch ultra-thin rechargeable polymer battery for powering said metal detector system.

3. The metal detector system of claim 1 wherein said detection comprises a presence of ferrous materials.

4. The metal detector system of claim 3 wherein said detection of said presence of said ferrous materials is indicated via sending said appropriate signal.

5. The metal detector system of claim 4 wherein said at least one audio speaker upon receipt of said appropriate signal causes said alarm to emit an audible signal.

6. The metal detector system of claim 5 wherein said sensor is able to determine a location via coordinates of an intruder having a presence of said ferrous material.

7. The metal detector system of claim 6 wherein said sensor is able to relay the location of the intruder to a remote electronic device.

8. The metal detector system of claim 7 wherein said remote electronic device comprises
a smart phone.

9. The metal detector system of claim 7 wherein said remote electronic device comprises a non-smart phone.

10. The metal detector system of claim 8 wherein said smart phone comprises and operates a mobile software application.

11. The metal detector system of claim 6 wherein said sensor is able to relay the location of the intruder to an already-installed security system.

12. The metal detector system of claim 11 wherein said already-installed security system is in communication with a police force.

13. The metal detector system of claim 12 wherein said police force is able to be notified of the location of said intruder.

14. The metal detector system of claim 1 wherein said detection comprises a presence of non-ferrous materials.

15. The metal detector system of claim 1 wherein said sticky pad is in a rolled-up condition prior to installation for ease of shipping.

16. The metal detector system of claim 1 wherein said door frame comprises a metal
frame in a rectangular shape.

17. A metal detector system comprising:
at least one transmitter coil configured to create an electromagnetic field;
at least one sensor comprising a receiver coil to detect electromagnetism;
a control;
at least one audio speaker to emit alarm sounds upon receiving an appropriate signal;
at least one battery;
a Wi-Fi connector to facilitate internet connection and allows Wi-Fi capability;
a top cover which covers a top part of a care metal detector;
a base; and
a Wi-Fi extender housing to house a circuit, the at least one battery and the Wi-Fi connector; and a Wi-Fi circuit board; said Wi-Fi connectors connectable to a Wi-Fi antenna, said Wi-Fi antenna extending a useful envelope of the Wi-Fi capability of the care metal detector; a Wi-Fi extender top to covers the Wi-Fi extender housing; a Wi-Fi extender antenna link to connect the Wi-Fi capability to the Wi-Fi antenna; and
a sticky pad for removably mounting said metal detector system to a door frame; and
wherein said at least one battery comprises 0.9 inch ultra-thin rechargeable polymer battery for powering said metal detector system;
wherein said detection comprises a presence of ferrous materials;
wherein said detection of said presence of said ferrous materials is indicated via sending said appropriate signal;
wherein said at least one audio speaker upon receipt of said appropriate signal causes said alarm to emit an audible signal;
wherein said sensor is able to determine a location via coordinates of an intruder having a presence of said ferrous material;
wherein said sensor is able to relay the location of the intruder to a remote electronic device;
wherein said remote electronic device comprises a smart phone;
wherein said smart phone comprises and operates a mobile software application;
wherein said sensor is able to relay the location of the intruder to an already-installed security system;
wherein said already-installed security system is in communication with a police force; and
wherein when mounted said metal detector system forms an inverted U, starting at a bottom of the door frame, climbing to a top of the door frame, cutting across the top of the door frame, and descending from the top of the door frame to the bottom of the door frame, and configured to create an electromagnetic field in said door frame for use in detection.

18. The metal detector system of claim 17 further comprising a kit including:
said metal detector system, and
a set of user instructions.

19. A method of using a metal detector system comprising the steps of:
providing said metal detector system;
installing said metal detector system to existing door frames; and
installing a mobile software application.

20. The method of claim 19 further comprising the steps of: connecting a smart phone
with said mobile software application to an internet via Wi-Fi.
